(19) United States
(12) Patent Application Publication
(10) Pub. No.: US 2010/0154901 A1
(43) Pub. Date: Jun. 24, 2010

(54) Faucet Structure

(76) Inventor: Kim Chang, Taichung City (US)

Correspondence Address: SENNIGER POWERS LLP, 100 NORTH BROADWAY, 17TH FLOOR, ST LOUIS, MO, 63102, US

(21) Appl. No.: 12/432,399

(22) Filed: Apr. 29, 2009

(30) Foreign Application Priority Data
Dec. 22, 2008 (TW) 97223110

(51) Int. Cl. F16K 15/00

(52) U.S. Cl. 137/515

(57) ABSTRACT

A faucet system includes a metallic outer pipe, an inner pipe made of plastic material, and a valve. Inner walls of the outer pipe having an appropriate distance near a top end of the outer pipe include a helical threads section. A first pipe section is at one end of the inner pipe includes ringed grove and backflow ring. The first pipe section of the inner pipe has a circumference that is smaller than rest of the inner pipe. A second pipe section is at the other end of the inner pipe and has a circumference that is larger than the rest of the inner pipe. The second pipe section forms a resistance section. The inner pipe is made of plastic material.

### BACKGROUND OF THE INVENTION

1. Field of the Invention

This invention generally relates to an improvement of water faucet or water pipe system. In particular, embodiments of the invention relate to using a combination of an inner tube, an outer tube and a valve, each serves as a separate and independent unit, to form a faucet system.

2. Background of the Invention

According to an existing technology illustrated in FIG. 1, a common faucet inlet pipe 10 has a metallic outer pipe 11. The outer pipe 11 includes an inner pipe 12 enclosed therein and to extend the outer pipe 11. The inner pipe is made of plastic material. The inner pipe 11 also extends upward or longitudinally to include a valve 13. The inner pipe 12 includes a joint member 121 that covers and connects with the top end of the outer pipe 11 through connecting pores or holes at the top end of the outer pipe 11. Through such connection, the inlet pipe 10 forms an integrated and fixed structure with the following pieces or parts: the outer pipe 11, the inner pipe 12 and the valve 13. Such a design prevents or avoids a direct contact between water or liquid in the inner pipe 12 and the metallic outer pipe 11. Such a design also prevents contamination of lead in the water as the water flows in the pipe 10.

However, prior technology suffers from a disadvantage as the pipe is constantly subjected to the impact of water flowing at a certain water pressure or an impact due to an unexpected external force to the pipe 10. These impacts cause damage to the pipe 10. Consequently, due to the integrated and fixed construction of the outer pipe 11, the inner pipe 12 and the valve 13, the pipe 10 cannot be disassembled. Hence, the entire pipe 10 needs to be replaced to address the damage to or even defects in the outer pipe 11, the inner pipe 12 or the valve 13. The need to replace the entire unit when only a part of it is damaged inevitably cause waste of undamaged part, increase the environmental cost and increase the cost of the repair.

### BRIEF SUMMARY OF THE INVENTION

Embodiments of the invention improve the existing faucet structure and overcome existing disadvantages by having the outer pipe, the inner pipe and the valve as individual removable pieces that are assembled to form the final faucet structure. At the same time, these individual pieces can be replaced or removed easily when any one of them is damaged or in need of repair. As such, aspects of the invention lower the cost of maintaining the faucet structure and avoid unnecessary repairs by replacing the entire faucet unit.

Alternative aspects of the invention apply helical threads or other connecting means to connect the outer pipe and the valve. An inner pipe also uses the helical threads to be tighten with the inner walls of the outer pipe. Due to this simplistic helical thread design, embodiments of the invention provide convenience in connecting the pieces together. Similarly, users of the faucet structure can easily take pieces part when a repair to one of the pieces is needed during a “Do-It-Yourself” or “Fix-It-Yourself” project.

In one embodiment, an improved faucet assembly structure includes an outer pipe. The outer pipe is made of a metallic material. The structure also includes an inner pipe, and the inner pipe is made of a thermoplastic polymer material. The structure also includes a valve set to actuate or regulate water flow. The outer pipe includes a helical threads section in its interior near one end of the outer pipe, and the inner pipe includes a first pipe member and a second pipe member. The first pipe member has a smaller circumference than that of the second pipe member, and the first pipe member is at one end of the inner pipe and includes a seal grove on its outer surface for accommodating a reciprocally matching seal. The second pipe is at the other end of the inner pipe and includes a blocking member. The valve set includes a blocking ring and a helical member, and the blocking ring has a larger circumference than that of the helical member. As an assembled faucet structure, the helical threads section of the outer pipe meet with the helical member of the valve set to form a connection, and an interior cavity of the outer pipe receives the first pipe member of the inner pipe whereby the seal is fitted within the interior cavity of the outer pipe to prevent contact between water with the metallic material of the outer pipe.

According to another embodiment, an improved faucet assembly structure includes an outer pipe that is made of a metallic material. An inner pipe that is made of a thermoplastic polymer or plastic material. The faucet structure includes a valve set. The outer pipe includes a helical threads section in its interior near one end of the outer pipe, and the inner pipe includes a first pipe member that includes a seal grove on its outer surface for accommodating a reciprocally matching seal. The valve set includes a blocking ring and a helical member, and the blocking ring has a larger circumference than that of the helical member. As assembled, the helical threads section of the outer pipe meet with the helical member of the valve set to form a connection, and an interior cavity of the outer pipe receives the first pipe member of the inner pipe whereby the seal of the first pipe member is tightly fitted within the interior cavity of the outer pipe to prevent contact between water with the metallic material of the outer pipe.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a plain view of an existing faucet structure.

FIG. 2 is an exploding perspective view of an assembled faucet structure according to an embodiment of the invention.

FIG. 3 is a cross-section view of the assembled faucet structure according to an embodiment of the invention.

FIG. 4 is a cross-section view of another embodiment of the assemble faucet structure of the invention.

Corresponding reference characters indicate corresponding parts throughout the drawings.

### DETAILED DESCRIPTION OF THE INVENTION

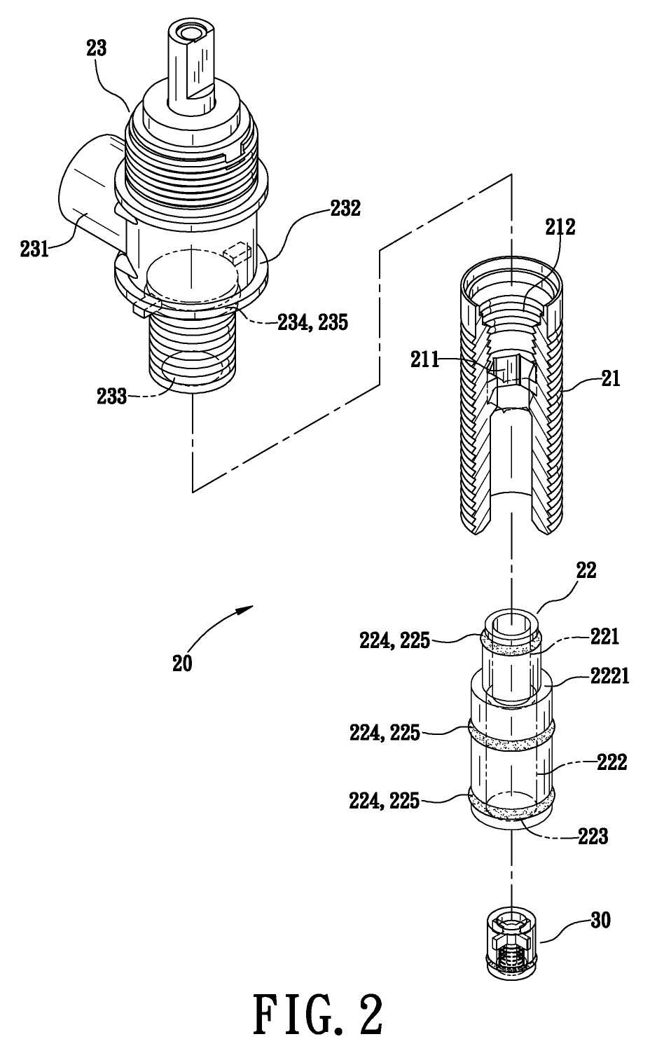

The following list shows reference characters used through FIGS. 2-4:
20—faucet structure
21—outer pipe
211—tool kit bore
212—inner helical thread member
22—inner pipe
221—first pipe member
2221—blocking member
222—second pipe member
223—slanted face member
224—seal grove
225—leak blocking seal
23—valve set
231—connecting member
232—blocking ring
233—helical member
234—seal grove
235—leak blocking seal
30—backflow valve
40—inlet pipe
41—locking head
411—water blocking seal

Referring to FIG. 2, an exploding perspective view illustrates a faucet structure of one embodiment of the invention. For example, a faucet structure 20 includes an outer pipe 21 having helical threads on the exterior surface of the outer pipe 21. In one embodiment, the outer pipe 21 may be cylindrical or other shapes. In one example, the helical threads may cover the entire or a partial exterior surface of the outer pipe 21. In another embodiment, the outer pipe 21 is made of metallic material, such as copper or lead.

In one embodiment, the outer pipe 21 includes an inner helical thread member 212 positioned near or substantially near an end of the outer pipe 21 that connects with a helical member 233 of a valve set 23. In one embodiment, the inner helical thread member 212 does not extend longitudinally through the entire length of the inner surface of the outer pipe 21. The outer pipe 21 also includes a tool kit bore 211 inside the outer pipe 21 and makes contact with the inner helical thread member 212. In one embodiment, the tool kit bore 211 has a polygon shape with an opening on the surface of the outer pipe 21 such that a wrench can be inserted through the bore 211 to tighten the outer pipe 21 to the helical member 233. For example, the tool kit bore 211 is a hexagon and accepts a hexkey wrench to tighten the outer pipe 21 to the helical member 233 through the inner helical thread member 212.

The faucet structure 20 also includes an inner pipe 22. The inner pipe 22 is made of plastic or thermoplastic polymer materials and is inserted into the outer pipe 21 from an end of the outer pipe 21 that does not connect with the helical member 233 of the valve set 23. The inner pipe 22 may be of a cylindrical shape or of other polygon shape that can be fitted inside the outer pipe 21. One end of the inner pipe 22 is configured to have a smaller diameter than the other end. For example, a first pipe member 221 of the inner pipe 22 has a smaller diameter than a second pipe member 222. The first pipe member 221 also includes a seal grove 224 to accept or receive a leak blocking seal or o-ring 225. The second pipe member 222, having a larger diameter, forms a blocking member 2221 at the location where the first pipe member 221 and the second pipe member 222 meet, as shown in FIG. 2. The second pipe member 222 also includes one or more seal groves 224 with matching leak blocking seals or rings 225 on the inner pipe 222. While there is one seal or o-ring 225 shown on the first pipe member 221 and two seals or o-rings on the second pipe member 222, it is to be understood that additional seals or o-rings may be used without departing from the scope or spirit of aspects of the invention.

The faucet structure 20 also includes a backflow valve 30 to be fitted inside the inner pipe 22 from the other end of the inner pipe 22. In one embodiment, the inner pipe 22 has an optional slanted face member 223 at the other end. In one embodiment, a slanted edge of the optional slanted face member 223 may be at an angle other than the right angle or 180 degree angle with respect to the other two adjacent edges of the inner pipe 22.

The faucet structure 20 includes the valve set 23 having a side connecting member 231 protruding or extending perpendicularly or about perpendicularly with respect to the helical member 233. The side connecting member 231 is used to connect with other pipes or valves. The valve set 23 includes valves inside (not shown) that react to the control of a faucet handle (not shown). For example, a user may actuate the faucet handle to adjust the amount of water or liquid flow. Other types of valves may be used without departing from the scope of embodiments of the invention.

The valve set 23 also includes a blocking ring 232 to stop or limit the longitudinal movement of the outer pipe 21 as the outer pipe 21 is screwed or tighten along the helical member 233 in an axial direction toward the blocking ring 232.

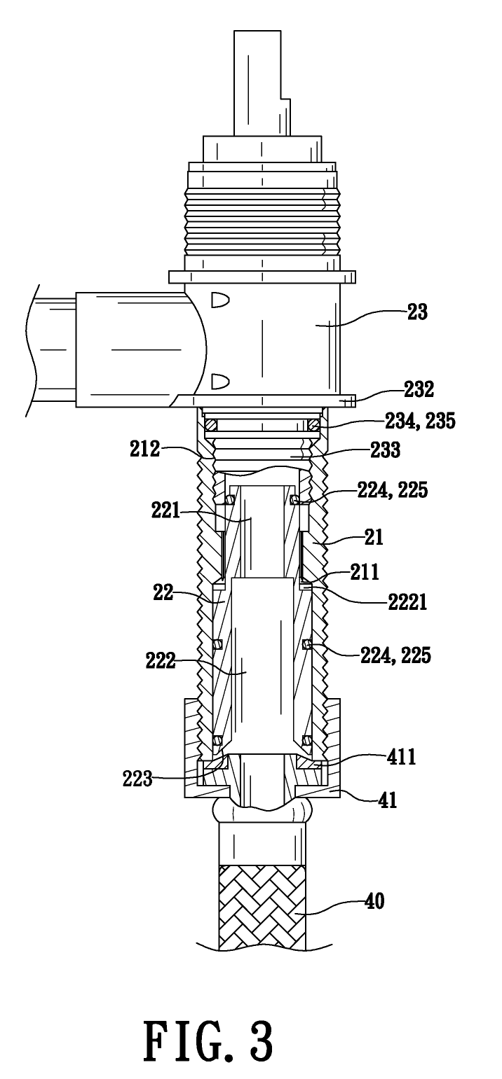

Referring now to FIG. 3, a cross-section view of the assembled faucet structure according to an embodiment of the invention. For assembly, the outer pipe 21 is fastened or coupled to the valve set 23 through the inner helical thread member 212 of the outer pipe 21 and the helical member 233 of the valve set 23. The leak blocking ring 235 of the valve set 23 is tightly coupled or tightly fit with inner walls of the top end the outer pipe 21 to form a first integration to achieve leakage blocking or prevention or avoidance. In one embodiment, a tool can be inserted into the tool kit bore 211 such that a user can operate the tool to further tighten the outer pipe 21 to grip to the valve set 23 to enhance a second level of integration or bonding between the outer pipe 21 and the valve set 23. Next, the first pipe member 221 of the inner pipe 22 is connected with the combined or joined outer pipe 21 and the valve set 23 by inserting from the bottom end of the combined outer pipe 21. For example, as one end of the combined outer pipe 21 is already connected with the valve set 23, the other end of the outer pipe 21 now receives the first pipe member 221 of the inner pipe 22. As such, as the first pipe member 221 of the inner pipe 22 is inside the combined outer pipe 21, the blocking member 2221 of the inner pipe 22 will set or limit the relative movement of the tool kit bore 211, thus causing or achieving a goal of fixing the position of the inner pipe 22 within the outer pipe 21. In addition, as the first pipe member 221 is inserted into the combined outer pipe 21, the top of the first pipe member 221 is pushed against and inserted into the interior of the helical member 233 of the valve set 23 such that the leak blocking seal 225 on the first pipe member 221 can be inside the helical member 233 of the valve set 23 to further prevent water leakage. The prevention or avoidance of water leakage is further enhanced as the additional leak block seals 225 on the second pipe member 222 of the inner pipe 22 are inside the combined outer pipe 21 or are within the interior of the outer pipe 21.

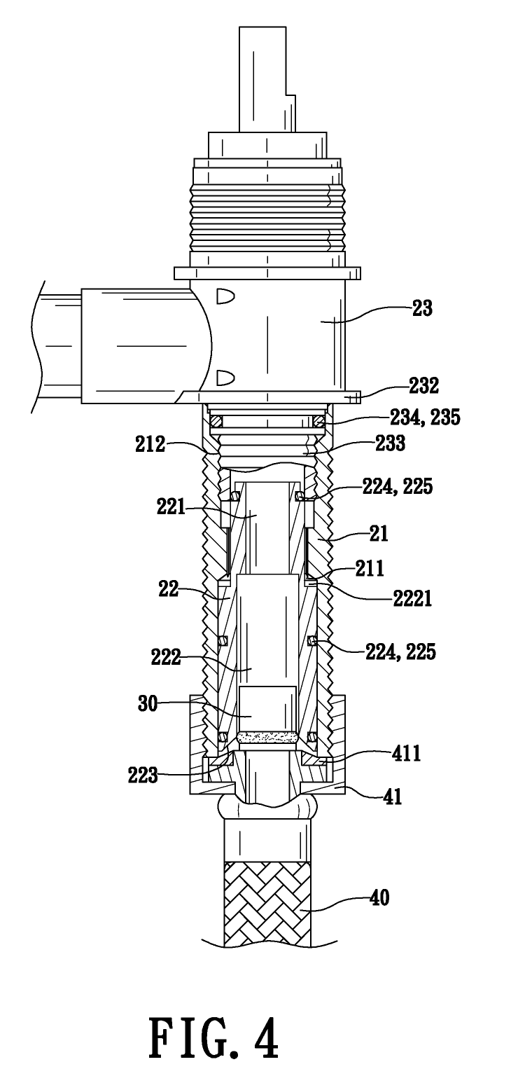

As further illustrated in FIG. 4, a cross-section view of another embodiment of the assemble faucet structure of the invention. In this embodiment, the interior of the inner pipe 22 forms an accommodating cavity to reciprocally match the backflow valve 30. For example, the backflow valve 30 inserts into the inner pipe 22 from the bottom end to prevent backflow problems. In another embodiment, the inner pipe 22 may include another water blocking seal or ring 411 at the end where the backflow valve 30 is installed. The water blocking seal or ring 411 includes a locking head 41 to tighten the water blocking seal 411 to tightly meet or is coupled with the slanted face member 223 to further prevent water leakage. Therefore, when an inlet pipe 40 is connected to the assembled faucet structure, the water will not come in contact with the metallic outer pipe 21. At the same time, using the inner pipe 22 to separate the water from the outer pipe 21, one may use a less expensive metallic material for the outer pipe 21 to save cost. In addition, the assembled elements of embodiments of the invention enable one to remove parts or replace parts for repair or maintenance without replacing the entire faucet structure 20.

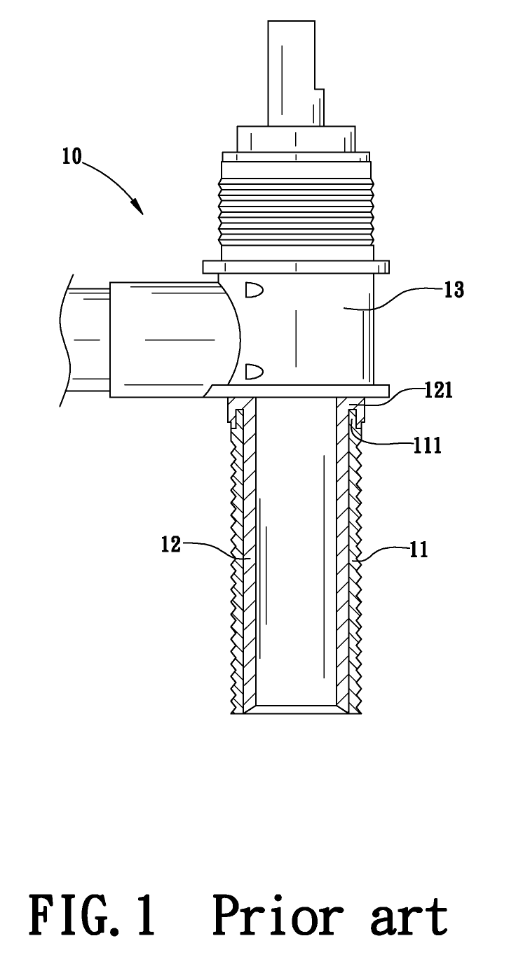

Unlike the prior technology shown in FIG. 1 which has no helical groves or threads inside the outer pipe 11, aspects of the invention provide the outer pipe 21 with helical groves or threads to receive the inner pipe 22. As such, the outer pipe 21 can be screwed or tightened to the valve set 23 and the outer pipe 21 to receive the inner pipe 22. As illustrated in FIG. 1, the outer pipe 11 merely includes connecting joints or hooks that connect with the inner pipe 12 as the inner pipe 12 is extruded such that the outer pipe 11 and the inner pipe 12 can be joined and fixed together. Also, the valve 13 is constructed or formed as one unit as the inner pipe 12. In other words, a housing or casing of the valve 13 is extruded during the production process as part of the inner pipe 12 before a valve set is placed therein to regulate or control the flow of water or liquid in the inner pipe 22. As illustrated above, aspects of the invention improve over the prior art design of the faucet structure to improve flexibility and other advantages described herein.

Obviously numerous modifications and variations of the present invention are possible in light of the above teachings. It is therefore understood that within the scope of the appended claims, the invention may be practiced otherwise than as specifically described herein.

What is claimed is:

1. An improved faucet assembly structure, comprising
an outer pipe, said outer pipe being made of a metallic material;
an inner pipe, said inner pipe being made of a thermoplastic polymer material;
a valve set,
wherein the outer pipe includes a helical threads section in its interior near one end of the outer pipe,
wherein the inner pipe comprises a first pipe member and a second pipe member, said first pipe member having a smaller circumference than that of the second pipe member, said first pipe member being at one end of the inner pipe and including a seal grove on its outer surface for accommodating a reciprocally matching seal, said second pipe being at the other end of the inner pipe and including a blocking member,
wherein the valve set comprises a blocking ring and a helical member, said blocking ring having a larger circumference than that of the helical member, and
wherein the outer pipe, the inner pipe and the valve set can be assembled to form the improved faucet assembly structure, wherein the helical threads section of the outer pipe meet with the helical member of the valve set to form a connection, and an interior cavity of the outer pipe receives the first pipe member of the inner pipe whereby the seal is fitted within the interior cavity of the outer pipe to prevent contact between water with the metallic material of the outer pipe.

2. The faucet assembly structure of claim 1, wherein the inner pipe further comprises a backflow valve.

3. The faucet assembly structure of claim 1, wherein the second pipe member of the inner pipe further comprises at least one seal grove for creating accommodating cavity for at least one reciprocally matching leak seal to further tightly fit the interior of the outer pipe to further prevent leakage.

4. The faucet assembly structure of claim 1, wherein the inner pipe comprises a cylindrical shape or a polygonal shape.

5. An improved faucet assembly structure, comprising:
an outer pipe, said outer pipe being made of a metallic material;
an inner pipe, said inner pipe being made of a thermoplastic polymer material;
a valve set,
wherein the outer pipe includes a helical threads section in its interior near one end of the outer pipe,
wherein the inner pipe comprises a first pipe member including a seal grove on its outer surface for accommodating a reciprocally matching seal,
wherein the valve set comprises a blocking ring and a helical member, said blocking ring having a larger circumference than that of the helical member, and
wherein the outer pipe, the inner pipe and the valve set can be assembled to form the improved faucet assembly structure, wherein the helical threads section of the outer pipe meet with the helical member of the valve set to form a connection, and an interior cavity of the outer pipe receives the first pipe member of the inner pipe whereby the seal of the first pipe member is tightly fitted within the interior cavity of the outer pipe to prevent contact between water with the metallic material of the outer pipe.

6. The faucet assembly structure of claim 5, wherein the first pipe member of the inner pipe further comprises a second pipe member at one end, said second pipe member having a larger circumference than that of the first pipe member, said second pipe member forming a blocking section.

7. The faucet assembly structure of claim 5, wherein the inner pipe further comprises a backflow valve.

8. The faucet assembly structure of claim 6, wherein the second pipe member of the first pipe member further comprises at least one seal grove for creating accommodating cavity for at least one reciprocally matching leak seal to further tightly fit the interior of the outer pipe to further prevent leakage.

9. The faucet assembly structure of claim 5, wherein the inner pipe comprises a cylindrical shape or a polygonal shape.
